(19) United States
(12) Patent Application Publication
(10) Pub. No.: US 2025/0238663 A1
(43) Pub. Date: Jul. 24, 2025

(54) SYSTEMS AND METHODS FOR GENERATING SYNTHETIC DATA

(71) Applicant: ACCENTURE GLOBAL SOLUTIONS LIMITED, Dublin 4 (IE)

(72) Inventors: Adolfo G. RAMIREZ-ARISTIZABAL, San Francisco, CA (US); Jordan Alexander ACKERMAN, San Francisco, CA (US); Michael KUNIAVSKY, San Francisco, CA (US)

(73) Assignee: ACCENTURE GLOBAL SOLUTIONS LIMITED, Dublin 4 (IE)

(21) Appl. No.: 19/034,105

(22) Filed: Jan. 22, 2025

Related U.S. Application Data
(60) Provisional application No. 63/624,769, filed on Jan. 24, 2024.

(51) Int. Cl. G06N 3/048; G06N 3/08

(52) U.S. Cl. CPC G06N 3/048; G06N 3/08

(57) ABSTRACT

Systems and methods for generating synthetic data is disclosed. The system includes a convolutional neural network having an encoder, a latent space, and a decoder. The encoder/decoder is trained to generate synthetic datasets having variability with respect to an input dataset. The variability may be introduced via compression and expansion of the data processed via the latent space, as well as via one or more selectively activatable dropout layers of the encoder. The encoder and decoder may be configured to shape data during the encoding/decoding process according to a number of channels in the input data, where the synthetic data produced by the encoder/decoder retains one or more signals of interest present in the input data.

### TECHNICAL FIELD

The present application relates to machine learning-based systems and more specifically, to systems and methods for generating synthetic data.

### BACKGROUND

Machine learning has become an important tool to aid in our understanding of systems and signals within the human body. For example, machine learning may be used to study brain signals, such as through electroencephalography (EEG) data, which may provide insights into causes of diseases as well as potential treatments of those diseases. However, challenges exist with respect to the study of such signals using machine learning. For example, to study brain and other signals of the human body using machine learning, a large volume of data is needed to perform training of machine learning model(s). However, access to large datasets of EEG and other types of data is not readily available (e.g., due to data privacy laws, medical record protections, etc.), limiting the ability to effectively train machine learning models and hindering performance of the machine learning models. One method that has been proposed to address data privacy for EEG data includes simple obfuscation or disassociation of the patient identity from the EEG data (e.g., such as in anonymizing the labels of patient data such as patient name, and other personably identifiable information describing the data in text). However, advances in artificial intelligence capabilities have proven that it may be possible to extract features from EEG data (i.e., numeric values, etc.) that may enable identification of the patient to which the EEG data belongs, thereby limiting the benefits of separating the patient's personally identifiable information from the EEG data.

Synthetic data refers to artificially generated data that mimics real-world data while maintaining its statistical properties. It is often used in various fields, such as machine learning, data analysis, and software testing, where access to real data may be limited, sensitive, or costly. Hence, synthetic data has been investigated as a method that may be used to bridge the data collection gap and enable creation of larger datasets that may be used to train machine learning models and develop machine learning-based applications. However, current models used for machine learning applications involving EEG data, including techniques for generating synthetic EEG data, have efficiency limitations that make their data processing more energy hungry and time consuming. For example, existing model approaches for generating synthetic EEG data are designed to operate on single channel data (e.g., for feature extraction using Fourier transforms) and are not capable of processing multi-channel EEG data. Additionally, such models have an extremely large number of parameters (e.g., 100 million parameters, 1.5 billion parameters, or more), making them difficult to train. Optimization is also a challenge, with prior models requiring optimization to be performed using early stopping by a researcher and/or requiring 1,000 training epochs or more to achieve model convergence during finetuning. As can be appreciated from the foregoing, while approaches for generating synthetic EEG data exist, such techniques suffer from several drawbacks that negatively impact their performance.

### SUMMARY

Implementations of the present disclosure are generally directed to systems, methods, and computer-readable storage media that support an architecture for designing encoder/decoders operable to generate synthetic datasets based on multi-channel data.

In general, a system including an encoder/decoder architecture for generating synthetic data is disclosed. The system includes a processor, and a memory communicably coupled to the processor, wherein the processor is configured to receive an input data from a plurality of data sources, wherein the input data corresponds to a multi-channel data, and wherein the input data comprises one of a raw data and a synthetic data and wherein the input data comprises a source dimension, extract a plurality of features from the received input data based on a plurality of channels corresponding to the received input data, and process the extracted plurality of features based on a plurality of factors corresponding to the plurality of channels. The processor is further configured to selectively activate a plurality of connections between network layers of an Artificial Intelligence (AI) model based on a configurable connection parameter, generate an encoded data corresponding to the processed plurality of features based on the selectively activated plurality of connections, generate a compressed dimensional data for the generated encoded data by compressing the generated encoded data into a lower dimension, convert the compressed dimensional data into a primary target dimensional data based on a synchronized plurality of factors symmetric to the plurality of factors corresponding to the plurality of channels, and generate at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest.

Further disclosed is a method of generating synthetic data for training a machine learning model. The method includes, receiving an input data from a plurality of data sources, wherein the input data corresponds to a multi-channel data, and wherein the input data comprises one of a raw data and a synthetic data and wherein the input data comprises a source dimension, extracting a plurality of features from the received input data based on a plurality of channels corresponding to the received input data and processing the extracted plurality of features based on a plurality of factors corresponding to the plurality of channels. The method further includes, selectively activating a plurality of connections between network layers of an Artificial Intelligence (AI) model based on a configurable connection parameter, generating an encoded data corresponding to the processed plurality of features based on the selectively activated plurality of connections, generating a compressed dimensional data for the generated encoded data by compressing the generated encoded data into a lower dimension, converting the compressed dimensional data into a primary target dimensional data based on a synchronized plurality of factors symmetric to the plurality of factors corresponding to the plurality of channels, generating at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest and training at least one machine learning model using the at least one primary synthetic dataset.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 is a block diagram of a system for generating synthetic datasets in accordance with aspects of the present disclosure;

FIGS. 2A-2D are block diagrams illustrating an exemplary machine learning architecture for generating synthetic data in accordance with the present disclosure may be applied;

FIGS. 3A-3C show diagrams illustrating exemplary processes for generating synthetic data in accordance with aspects of the present disclosure.

FIGS. 4-9 are diagrams illustrating exemplary performance metrics for systems and methods operating in accordance with aspects of the present disclosure; and

FIG. 10 is a flow diagram of an exemplary method for generating synthetic data in accordance with aspects of the present disclosure.

Like reference numbers and designations in the various drawings indicate like elements.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

The present disclosure describes systems, methods, and computer-readable storage media providing functionality that supports creation of synthetic data generators using an intelligent encoder/decoder architecture. The disclosed encoder/decoder architecture is operable to generate synthetic datasets based on multi-channel input data, where all channels are processed simultaneously. The encoder/decoder architecture may be implemented as a convolutional neural network (CNN) that is trained to generate synthetic datasets having variability with respect to the multi-channel input data. The variability may be introduced, at least in part, via shaping constraints imposed by the encoder/decoder, as well compression and expansion of the data during processing. The shaping constraints imposed by the encoder and decoder may be based on the number of channels within the input data. For example, multi-channel EEG data may have 128 channels and the shaping constraints applied by the encoder/decoder may be configured to process those 128 channels using a 2-dimensional representation. The encoder and decoder may be bridged by a latent space layer configured to compress (i.e., reduce a dimensionality of) encoded data output by the encoder and then expand the dimensionality of the compressed data prior to passing the higher dimension data to the decoder. The encoder includes one or more selectively activatable dropout layers configured to, when activated, disconnect connections between nodes and/or layers of the CNN, which increases the amount of variability with respect to input datasets and the output synthetic datasets. Despite the variability introduced by the encoder/decoder architectures disclosed herein, the synthetic data retains one or more signals of interest, thereby enabling the synthetic data to be used as training data for machine learning models. The disclosed encoder/decoder architectures are designed to operate with fewer computational resource requirements and improved performance as compared to prior approaches for generating synthetic data, as will become apparent from the detailed description below. Additionally, the variability provides a degree of anonymization with respect to the identify of an individual associated with the raw data from which synthetic data may be generated. Due to this anonymization, the synthetic data may be more readily shared (e.g., to support creation of larger datasets suitable for training machine learning models) in a manner that seeks to comply towards new and ever evolving privacy regulations and requirements.

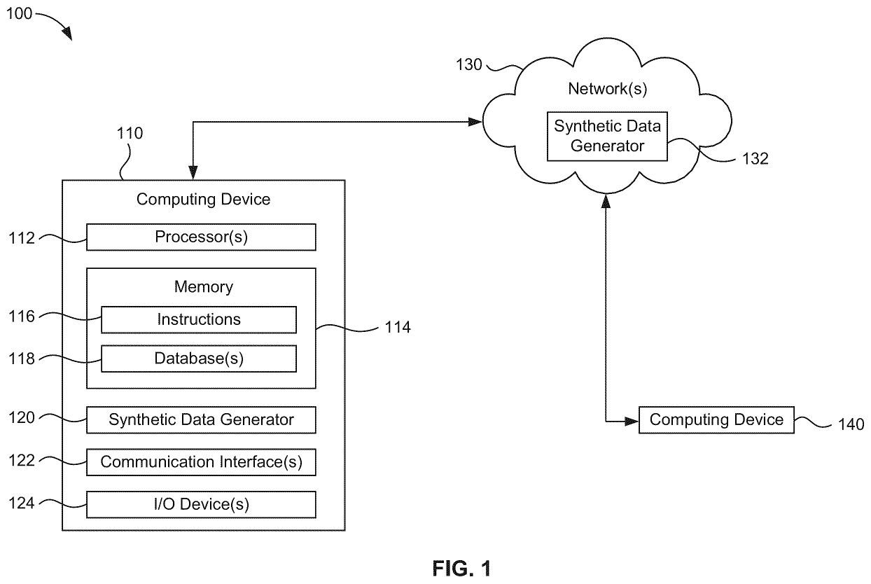

Referring to FIG. 1, a block diagram of a system for generating synthetic datasets in accordance with aspects of the present disclosure is shown as a system 100. In FIG. 1, the system 100 is shown as including a computing device 110 that includes one or more processors 112, a memory 114, a synthetic data generator 120, one or more communication interfaces 122, and one or more input/output (I/O) devices 124. The one or more processors 112 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the synthetic data generator device 110 in accordance with aspects of the present disclosure.

The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the entity device 110 may be stored in the memory 114 as instructions 116 that, when executed by the one or more processors 112, cause the one or more processors 112 to perform the operations described herein with respect to the synthetic data generator device 110, as described in more detail below. Additionally, the memory 114 may be configured to store one or more databases 118. Exemplary aspects of the one or more databases 118 are described in more detail below.

The one or more communication interfaces 122 may be configured to communicatively couple the synthetic data generator device 110 to external devices and systems via one or more networks 130, such as a computing device 140 (e.g., a computing device associated with a medical or other form of research facility). Communication between the synthetic data generator device 110 and the external devices and systems via the one or more networks 130 may be facilitated via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like). The one or more input/output (I/O) devices 124 may include one or more display devices, a keyboard, a stylus, one or more touchscreens, a mouse, a trackpad, a camera, one or more speakers, haptic feedback devices, or other types of devices that enable a user to receive information from or provide information to the synthetic data generator device 110.

The system 100, via the synthetic data generator device 110, is configured to generate synthetic data, such as synthetic EEG data, in a privacy preserving manner. For example, the synthetic data generator 120 may be configured to receive input EEG data and generate larger datasets of EEG data based on the input EEG data. In an embodiment of the present disclosure, upon receiving the input data, the synthetic data generator 120 extracts a plurality of features from the received input data based on a plurality of channels corresponding to the received input data and process the extracted plurality of features based on a plurality of factors corresponding to the plurality of channels. Then, the synthetic data generator 110 selectively activate a plurality of connections between network layers of an Artificial Intelligence (AI) model based on a configurable connection parameter and generates an encoded data corresponding to the processed plurality of features based on the selectively activated plurality of connections. Further, the synthetic data generator 110 compresses the generated encoded data into a lower dimension and converts the compressed dimensional data into a primary target dimensional data based on a synchronized plurality of factors symmetric to the plurality of factors corresponding to the plurality of channels. Then the synthetic data generator 110 generates at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest. The output EEG datasets, the synthetic dataset, may be suitable for use in training machine learning models. To illustrate, the output datasets may contain synthetic EEG data that may be used to train machine learning models to capture insights from the synthetic EEG data (e.g., interpret the synthetic EEG data to understand behaviors, thoughts, or other aspects of human brain or body function). However, due to the privacy preserving or anonymization of the synthetic EEG data, the synthetic EEG datasets output by the synthetic data generator 120 may be shared without running afoul of privacy regulations. This may enable machine learning applications for analyzing EEG data to be more thoroughly investigated, potentially leading to new discoveries with respect to healthcare and disease or other treatments. Exemplary operations for generating synthetic EEG data in a privacy preserving manner are described in more detail below. Furthermore, it is to be noted that while the system 100 is primarily described herein as being utilized to generate synthetic EEG data, the concepts described herein are not limited to EEG data. Instead, it should be understood that the machine learning techniques described herein may be applied to other types of signals, such as magnetoencephalography (MEG) signals, electrooculography (EOG) data, electroretinography (ERG) data, galvanic skin response data, electromyography (EMG) data, or other types of multichannel data, and may be used to generate synthetic data that overcomes the problems associated with the prior single-channel approaches, as will become apparent from the description below.

EEG data may be multi-channel data. However, prior approaches to generating synthetic EEG data are designed to operate EEG data, a single channel at a time. In an embodiment of the present disclosure, the synthetic data generator 120 is configured to generate synthetic EEG data based on a given set of input data, which may include multichannel raw EEG data (e.g., multi-channel EEG data), pre-processed EEG data (e.g., synthetic EEG data generated by the synthetic data generator 120), or combinations thereof. It is to be understood that while primarily described with respect to generation of synthetic EEG data, the synthetic data generator may support generation of synthetic data for any of the various other types of data described above or other types of data to which the concepts described herein may be applied.

The synthetic data generator 120 includes an encoder/decoder providing functionality to support generation of synthetic data. The encoder is configured to enforce shaping constraints on to the input data and introduce randomness to the input data. For example, the encoder may be configured to perform feature learning and abstraction on the input data. In an aspect, the encoder may include one or more dropout layers to generate synthetic data from a given set of input data. The one or more dropout layers may be selectively activated (e.g., turned on or off) during synthetic data generation and a configuration of the one or more dropout layers may be configurable to tune the outputs of the synthetic data generator 120.

The encoder/decoder may additionally include a middle layer, also referred to as a latent space layer. The middle layer is configured to compress the outputs of the encoder into a reduced dimension (e.g., as compared to the output of the encoder) to generate compressed dimensional data that captures at least a portion of the features extracted from the input data by the encoder. The middle layer is also configured to expand the reduced dimension data into a higher dimension form suitable as an input to the decoder. As described, the encoder identifies and extracts a plurality of features from the input data based on the channels, processes the features considering various factors corresponding to the channels, selectively activates specific connections in the AI model based on configurable parameters and produces encoded data corresponding to the processed features based on activated connections. Further, the latent space layer of the encoder compresses and stores the encoded data into a lower-dimensional format.

The decoder is configured to generate output data based on the output of the middle layer. For example, where the input data to the encoder/decoder is raw EEG (i.e., recordings of brain activity obtained via measurements by electrodes), the output of the decoder may be synthetic EEG data derived from the raw EEG data. In an embodiment, the decoder transforms the compressed data back into a usable format and generates a synthetic dataset based on the target dimensional data, effectively reconstructing the original multi-channel input. The target dimensional data as described herein refers to the desired characteristics or features of the output data. The synthetic EEG data may capture some signals present in the raw EEG data but is not an exact copy due to randomness and abstraction introduced by the encoder (e.g., due to the dropout layer or other features of the encoder) and/or middle layer (e.g., due to compression). In this manner, synthetic copies of EEG data suitable for research purposes (e.g., training artificial intelligence models, etc.) may be produced and shared without violating privacy regulations. Additionally, the synthetic data produced by the encoder/decoder of the synthetic data generator 120 may have additional operations performed on it without impacting the raw data, thereby preserving the state of the raw data and maintaining the confidentiality of the raw data. An exemplary architecture and operations for an encoder in accordance with aspects of the present disclosure are described in more detail below. It is noted that in addition to generating synthetic data from raw input data, the encoder/decoder may also be configured to generate large datasets via use of other forms of input data, such as synthetic input data sets. The ability to generate larger datasets may be particularly advantageous in certain fields, such as the study of EEG data, as it enables suitable datasets for use in training artificial intelligence models to be created despite limited availability of raw EEG data. Additionally, advantages and features of the synthetic data generator 120 are described in more detail below.

The one or more communication interfaces 122 may be configured to communicatively couple the computing device 110 to one or more remote computing devices 140 via one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5^{th} Generation (5G) communication standard, and the like). The one or more I/O devices 124 may include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 110. In some implementations, the computing device 110 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the computing device 110. It is noted that while FIG. 1 shows the computing device 110 as a standalone device (e.g., a server, a personal computing device, etc.) for purposes of illustration rather than by way of limitation and that the functionality provided by the computing device 110 may be provided in a distributed manner (e.g., via multiple computing devices 110) or in a cloud based implementation, shown as cloud-based synthetic data generator 132.

In FIG. 1 a computing device 140 is shown. The computing device 140 may be a research device, such as a device that may be used to train an artificial intelligence model using synthetic datasets generated using the functionality provided by the computing device 110. For example, EEG data may be provided to the computing device 110 to produce a set of training data using the synthetic data generator 120 and the synthetic data generation techniques described herein. The set of training data may be provided to the computing device 140 to train the artificial intelligence model, which may enable the artificial intelligence model to be trained to a sufficient level of performance (e.g., accuracy, recall, precision, etc.) because the generation of synthetic data using the techniques described herein enables larger datasets to be produced. Accordingly, artificial intelligence models trained using datasets including synthetic data generated by the computing device 110 may enable new insights and discoveries that may improve the treatment of medical conditions or enable new therapies to be developed. Moreover, because the synthetic data generated in accordance with the techniques disclosed herein may be separated from the raw data (e.g., raw EEG data, etc.), the synthetic datasets may be shared without running afoul of privacy regulations and requirements, enabling individuals to maintain the privacy of their sensitive data while still enabling the other advantages that are derived from the use of synthetic datasets generated by the computing device 110.

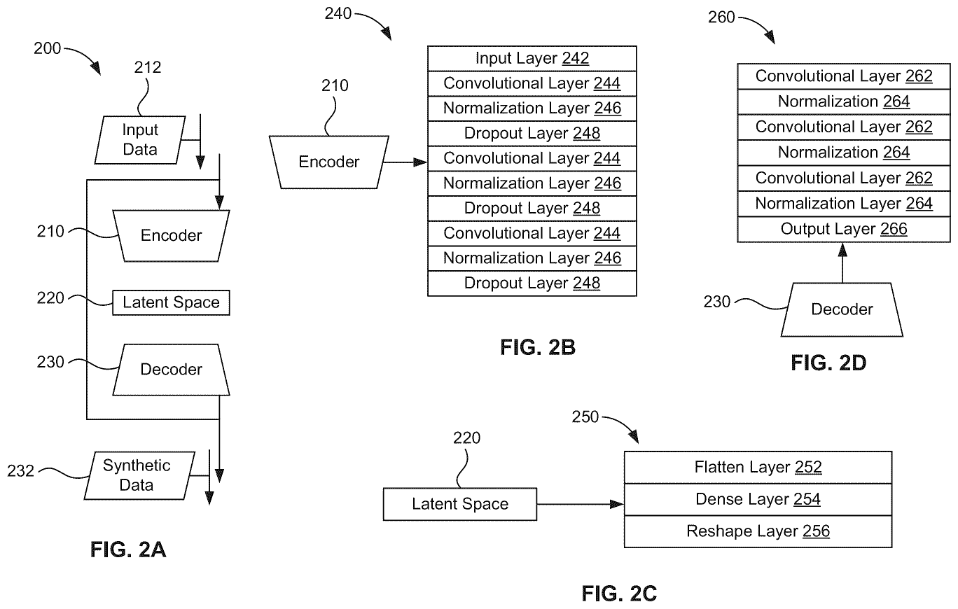

Referring to FIGS. 2A-2D, an exemplary architecture for generating synthetic data in accordance with aspects of the present disclosure is shown as an encoder/decoder architecture 200. In an aspect, the encoder/decoder architecture 200 may be utilized to provide the functionality described above with reference to the encoder/decoder of the synthetic data generator 120 of FIG. 1. As shown in FIG. 2A, the encoder/decoder architecture 200 includes an encoder 210, a latent space 220, and a decoder 230. The encoder/decoder architecture 200 is configured to receive input data 212 and to generate synthetic data 232. As explained above, the input data 212 may include raw data (e.g., raw EEG data or other types of multi-channel data) or may include synthetic data generated by the system disclosed in the present disclosure. That is, the input data itself may be the synthetic data. In a preferred embodiment, the input data to the system is the multi-channel raw data. It is noted that because the encoder/decoder architecture 200 is designed to operate on both raw and synthetic data, computing devices implementing an encoder/decoder in accordance with the concepts described herein are enabled to generate large datasets of synthetic data because a single piece of input data 212, such as a single EEG recording, may be used to output multiple pieces of synthetic data 232 (e.g., by cycling the synthetic data 232 back as input data 212).

An exemplary architecture for the encoder 210 is shown in FIG. 2B, which is a block diagram of an encoder architecture 240 in accordance with aspects of the present disclosure. As shown in FIG. 2B, the encoder architecture 240 includes an input layer 242, a plurality of convolutional layers 244, a plurality of normalization layers 246, and a plurality of dropout layers 248. In an aspect, the input layer 242 may be configured to control a dimensionality of the input data 212. For example, the input layer 242 may be configured to dictate a shape of the input data 212 during the encoding/decoding process. In an aspect, the shape of the input data 212 may be based on the number of channels the input data has according to [x, y, z], where [x, y, z] represents the shape of the data format. For example, ‘x’ may represent a number of recording channels, ‘y’ may represent a time length of data in samples, and ‘z’ may represent a depth length of data (e.g., in grayscale images the depth may be 1 and in RGB colored images the depth may be 3). It is noted that the number of channels (x) may be subject to change based on a variety of factors, such as the hardware of the EEG data recording equipment, the discretion of the researcher, or other factors. As another example, the time length (y) may also be subject to change at the discretion of the researcher and may control how long (i.e., a duration) of the recordings. The depth (z) may also be subject to change but typically is of depth=1. In some examples described herein, the input data 212 is multi-channel data (e.g., multi-channel EEG data) of having [x, y, z] configured to be [128, 128, 1], meaning the shape of the data format is 128 channels of time length 128 samples (e.g., because the recording sampling rate was 128, which equals 1 second of data), and a depth of 1, which means the model treats it like a gray scale image. Specifically, x=128 indicates that there are 128 different EEG channels being recorded, y=128 reflects that for each channel, data is collected for 128 time samples, which corresponds to a 1-second recording at a sampling rate of 128 Hz, and z=1 indicates that each channel's data is represented as a grayscale image, where the single depth dimension indicates that there's only one layer of intensity values. In an embodiment, the shape of the input data 212 is used to extract a plurality of features from the received input.

Each of the convolutional layers 244 may be configured to perform feature learning and data abstraction with respect to the input data 212 and more specifically, with the shaped input data output by the input layer 212 or an output of any intermediate layers between adjacent convolutional layers. In an aspect, the convolutional layers 244 may be two-dimensional convolutional layers having parameters configured to support evaluation of multi-channel data. For example, the convolutional layers 244 may utilize a kernel size (e.g., [25, 25]) that is substantially larger relative to prior single channel models, which enables the convolutional layers 244 of the encoder architecture 240 to consider each channel as an individual recording during learning and can maintain correlation between different channels of the data despite the presence of variability among the signals of each channel. Other non-limiting parameter values for the convolutional layers 244 may include: filters=64, strides [2, 2], activation function=rectified linear unit (ReLU), weight initialization=He_Uniform, kernel_regulizer=L2 (0.0000000001). It is noted that the exemplary parameter values described herein have been provided for purposes of illustration, rather than by way of limitation and the other parameters and parameter values may be used to design encoders in accordance with the concepts described herein.

The normalization layers 246 may be configured to perform batch normalization, which may stabilize learned values and speed up training. For example, multichannel data may represent more variability than single channel data and the normalization layers 246 help handle variability during the model training phase that may smooth out model learning. This may also help in having faster training periods.

The dropout layers 248 may be configured to generalize the input data 212 (e.g., as processed by preceding layers). In an aspect, the generalization provided by the dropout layers 248 may be achieved by randomly turning off connections between network layers. In an aspect, the dropout layers 248 may be selectively activated and deactivated (e.g., turned on and off). For example, input data 212 may be processed through the encoder 240 with zero or more of the dropout layers 248 turned on or turned off. By selectively activating (e.g., turning on) or deactivating (e.g., turning off) the dropout layers 248, each piece of input data (e.g., each EEG recording or other type of data) may be used to generate multiple pieces of synthetic data 232. To illustrate, raw EEG data may be provided as the input data 212 and used to generate a piece of synthetic data 232 (e.g., synthetic EEG data) while the dropout layers 248 are turned off. The synthetic 232 (i.e., a first piece of synthetic EEG data) may be fed back to the encoder/decoder as input data 212 for processing with the dropout layers are turned off to produce a new piece of synthetic data. The raw EEG data or synthetic EEG data may then be provided as input to the encoder/decoder while one or more of the dropout layers 248 are turned on, thereby producing new pieces of synthetic EEG data. In this manner, the dropout layers may be activated or deactivated to enable generation of multiple pieces of synthetic data based on a single piece of raw EEG data.

In addition to selectively turning the dropout layers 248 on an off to change the outputs of the encoder 240 (and the resulting synthetic data output by the decoder), each of the dropout layers 248 may have a configurable dropout parameter that specifies the number of connections that are randomly turned off during processing. For example, the configurable dropout parameter may be configured to a particular percentage (e.g., 5%, 10%, 15%, 2-5%, 4-7%, 5-20%, or another value). In an aspect, all dropout layers 248 may have the same configurable dropout parameter. In an additional or alternative aspect, different dropout layers 248 may be configured with different configurable dropout parameter values to provide robust mechanisms for generating different pieces of synthetic data, further contributing to the ability to create larger datasets suitable for use in training artificial intelligence models to a desired level of performance.

An exemplary architecture for the latent space 220 is shown in FIG. 2C, which is a block diagram of latent space architecture 250 in accordance with aspects of the present disclosure. As shown in FIG. 2B, the latent space architecture 250 includes a flattening layer 252, a dense layer 254, and a reshaping layer 256. The flattening layer 252 may be configured to reduce a dimensionality of the output of the encoder 240. For example, the output of the encoder 240 may be two-dimensional data and the flattening layer 252 may convert the two-dimensional data to a single dimension, thereby compressing the output of the encoder 240. The dense layer 254 may be configured as an all-to-all network configured to store the compressed form of the data (e.g., the output of the flattening layer 252). In an aspect, the dense layer may have a configurable size (e.g., 256) and may have a ReLU activation layer. The reshaping layer 256 may be configured to control a dimensionality of the input data 212. For example, the reshaping layer may convert the output of the dense layer to a higher dimension representation, such as a two-dimensional representation (e.g., the same as the output of the encoder 240). In this manner, the latent space architecture 250 may serve as a bridge layer between the encoder 210 and the decoder 230, which is described below.

An exemplary architecture for the decoder 230 is shown in FIG. 2D, which is a block diagram of a decoder architecture 260 in accordance with aspects of the present disclosure. As shown in FIG. 2D, the decoder architecture 260 includes a plurality of convolutional layers 262, a plurality of normalization layers 264, and an output layer 266. The convolutional layers 262 may be configured to perform feature assembly based on the output of the latent space 250 or preceding layer of the decoder architecture 260. The feature assembly may attempt to take the preceding layer output and use it to reconstruct the input data 212. In an aspect, the convolutional layers 262 may be convolutional layers having parameters that are the same as, or similar to the parameters of the convolutional layers 244 described above. The normalization layers 264 may be configured to perform batch normalization, which may stabilize learned values and speed up training. The output layer 266 is configured to output synthetic data having the same constraints as the input data 212. For example, the output layer 266 may shape the output data to have the same dimensions as the shaping performed by the input layer 242. In an aspect, the output layer 266 may be configured without strides to allow for extra data processing without changing desired output format. As a non-limiting example, where the input data 212 corresponds to raw or synthetic EEG data (i.e., multi-channel EEG data), the synthetic data 232 produced by the output layer 266 may be synthetic multi-channel EEG data.

Using the exemplary architectures described above provides several advantages over prior synthetic EEG data generators. For example, the encoder/decoder architecture described above provides a reduced set of trainable parameters (e.g., approximately 68 million trainable parameters as compared to 100 million to over 1 billion trainable parameters in prior approaches). Additionally, despite the smaller number of trainable parameters, the disclosed encoder/decoder architecture operates on multi-channel data while prior approaches were restricted to single channel implementations. An additional advantage is that the encoder/decoder designed as described herein may be trained more quickly as compared to prior single channel approaches. For example, the disclosed encoder/decoder architecture may converge during training in approximately 300 epochs or less, as compared to requiring approximately 1,000 epochs with prior techniques. Accordingly, the multi-channel encoders/decoders described herein provide a technical improvement over prior techniques and enable computing devices to train encoders/decoders more efficiently. In an aspect, the training may be performed using a Adam optimizer (e.g., as the learning optimizer), and may have a learning rate of approximately 0.09. A means squared error may be used as the loss function.

As can be appreciated from the foregoing, an encoder/decoder designed in accordance with the concepts described herein may be trained more quickly, and once trained, be used to produce synthetic data that may be used as additional training data for training the encoder/decoder or a machine learning model. For example, a dataset of raw EEG data may be used to train an encoder/decoder model designed as described herein, which may converge in approximately 300 epochs (i.e., approximately ⅓ the number of epochs required by prior single-channel approaches). Once trained, the dataset of raw EEG data may be passed through the encoder/decoder to produce a synthetic EEG dataset. The synthetic data may then be passed through the encoder/decoder, along or in combination with portions of the original raw EEG dataset, to produce additional synthetic EEG data. Moreover, the various raw and synthetic datasets may be passed through the encoder/decoder with the dropout layers activated or deactivated and/or with different dropout layer parameter values to further vary the synthetic data that is output by the encoder/decoder. This enables a greater volume of synthetic data to be generated based on the initial raw EEG dataset as compared to prior approaches, which facilitates further training of models based on EEG and other forms of multi-channel data.

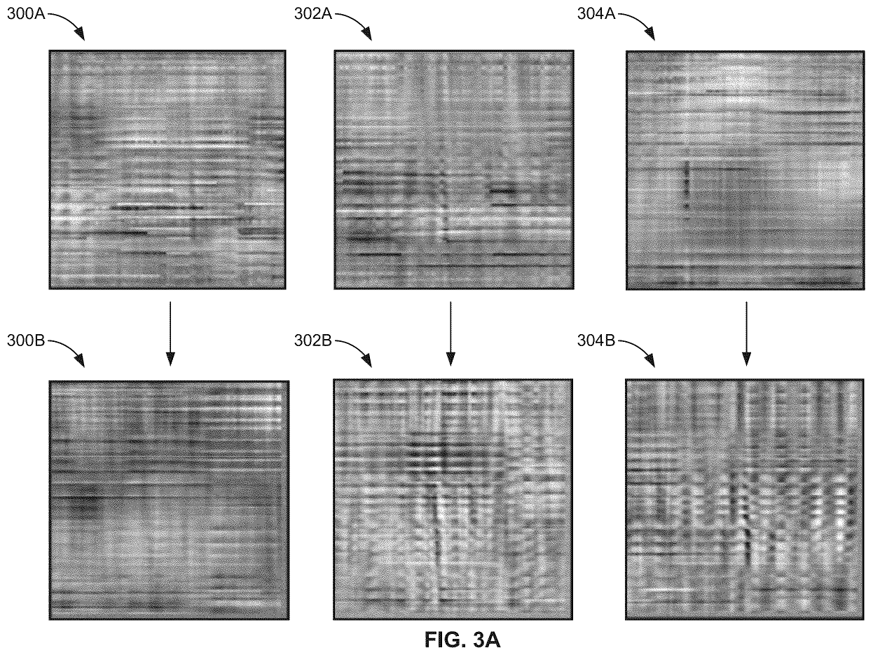

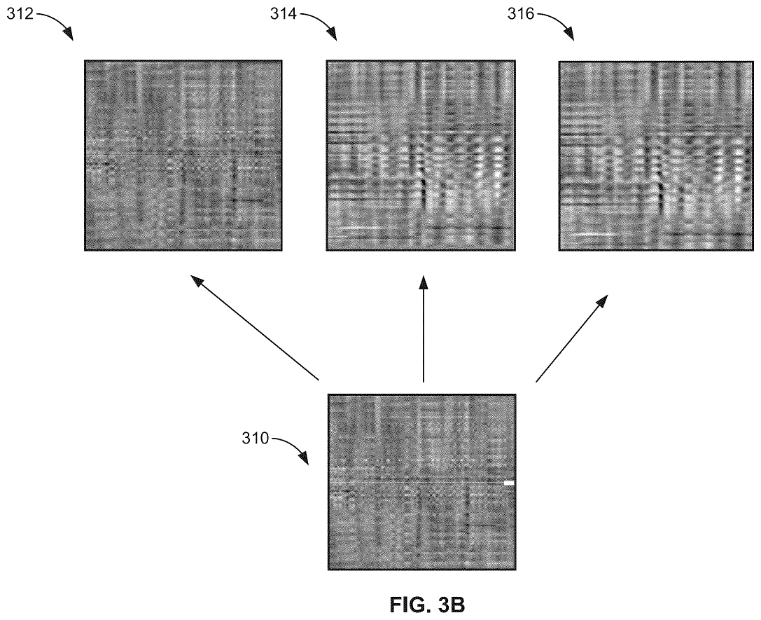

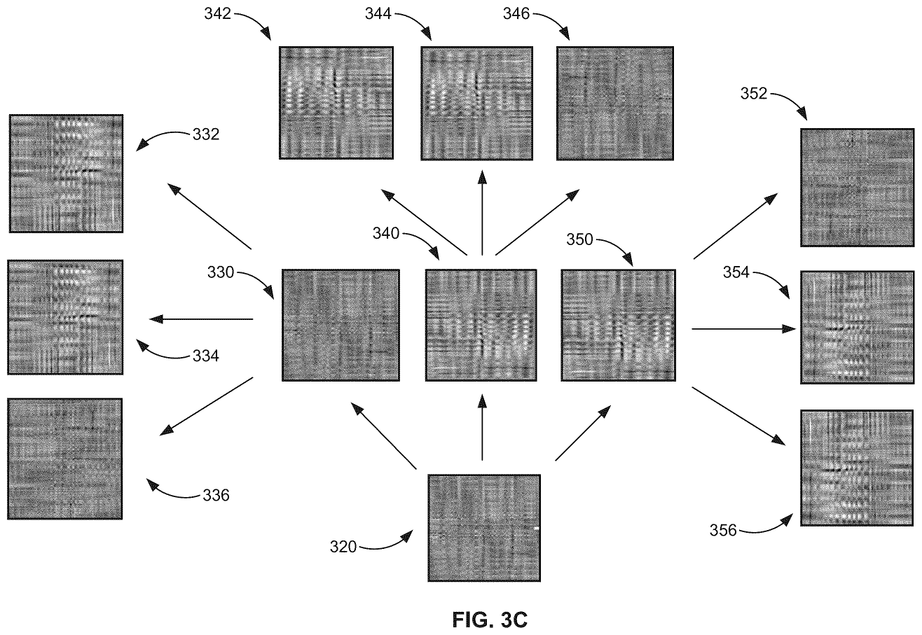

Having described various features for designing and training an encoder/decoder model for generating synthetic data in accordance with aspects of the present disclosure, exemplary aspects of generating synthetic data will now be described with reference to FIGS. 3A3C. In FIG. 3A, screenshots illustrating synthetic EEG data generated from raw EEG data in accordance with aspects of the present disclosure are shown. In particular, FIG. 3A shows raw EEG data 300A, 302A, 304A and corresponding synthetic data 300B, 302B, 304B. In the example of FIG. 3A, raw EEG data 300A corresponds synthetic data 300B, raw EEG data 302A corresponds synthetic data 302B, and raw EEG data 304A corresponds synthetic data 304B. As can be appreciated from the foregoing, the exemplary raw and synthetic data pairs shown in FIG. 3A illustrate a process for generating synthetic EEG data with a one to one correspondence between raw input data and synthetic output data (i.e., one piece of synthetic EEG data generated for each piece of raw EEG data received as input). Stated another way, FIG. 3A illustrates that, for a given dataset of raw EEG data, the encoder/decoder architecture disclosed herein may generate a synthetic representation of that dataset. As explained above, the synthetic dataset may provide for anonymization of the raw EEG data due to the introduction of variability in the synthetic data outputs due to the compression of the input data by the encoder and latent space, and expansion by the decoder. However, it should be appreciated that the synthetic data generation techniques disclosed herein may be utilized to generate multiple pieces of synthetic EEG data from a single piece of raw EEG data and that additional variability (i.e., as compared to the variability provided with the dropout layer(s) turned off) may be provided during synthetic data generation by activating one or more of the dropout layers.

For example, and referring to FIG. 3B, diagrams illustrating generation of multiple pieces of synthetic data from a single piece of raw data are shown. As explained above, the exemplary encoder/decoder architecture described above with reference to FIGS. 1 and 2A to 2D provides robust configuration options for tuning synthetic data generation processes to enable creation of large synthetic datasets from both raw input data and synthetic data. In the illustrative example of FIG. 3B the input data 310 (e.g., raw EEG data or another form of data for which the encoder/decoder architectures disclosed herein may be applied) is passed to the encoder/decoder multiple times to obtain different pieces of synthetic data 312, 314, 316. During a first iteration the input data 310 may be provided to the encoder/decoder to produce the synthetic data 312. During the first iteration the encoder may be configured with the dropout layers turned off, as described above with reference to FIG. 3A. In a second iteration the same piece of input data 310 may be provided to the encoder/decoder to produce the synthetic EEG data 314, and in the second iteration the encoder may be configured with one of the dropout layers turned on. A third iteration may be performed in which the input data 310 is provided to the encoder/decoder to produce the synthetic data 316, and in the third iteration the encoder may be configured with a different one of the dropout layers turned on. In an aspect, the dropout layer activated during the second iteration may be activated or deactivated during the third iteration. In an additional or alternative aspect, the dropout layer(s) activated during the third iteration may be the same as the dropout layer(s) activated during the second iteration, but may utilize a different parameter setting (e.g., 10% in the second iteration and 5% in the third iteration). Thus, by simply changing a configuration of the dropout layer parameter value(s), which control the number of connections in a network that are randomly disconnected, different variability in the output synthetic data may be obtained.

As can be appreciated from the foregoing, selective activation and deactivation of the dropout layers of the encoder may enable multiple pieces of synthetic EEG data to be generated from a single piece of raw EEG data, thereby enabling larger datasets of EEG data to be generated using the synthetic data generation techniques disclosed herein. It is noted that since the dropout layers, when activated, randomly disconnect portions of the network, the same dropout layer configuration (i.e., the same activation of the dropout layers) may also be used to obtain multiple pieces of synthetic data from the same piece of input data (e.g., due to randomness naturally resulting in different results from one iteration to another).

To generate even larger datasets of synthetic data, such as synthetic EEG data, the encoder/decoder may be provided with synthetic data as input. For example, and referring to FIG. 3C, diagrams illustrating additional exemplary aspects for generating synthetic data in accordance with the concepts disclosed herein are shown. In particular, the process shown in FIG. 3C illustrates generation of multiple pieces of different synthetic data from a single piece of raw input data (e.g., raw EEG data). To illustrate, input data 320 (e.g., raw EEG data) may be passed to the encoder/decoder to generate multiple pieces of synthetic data 330, 340, 350, as described above with reference to FIG. 3B. Each piece of synthetic data 330, 340, 350 may then be provided to the encoder/decoder to generate additional pieces of synthetic data. For example, synthetic data 330 may be used to produce synthetic data 332, 334, 336, synthetic data 340 may be used to produce synthetic data 342, 344, 346, and synthetic data 350 may be used to produce synthetic data 352, 354, 356. As can be appreciated from the example illustrated in FIG. 3C, encoder/decoder architectures in accordance with the present disclosure may greatly increase the availability of datasets of EEG and other types of data that may be subject to privacy regulations that limit the sharing of such data for purposes of machine learning and limit the use of such techniques for studying the signals contained in such data to further development of therapies to treat medical conditions. Moreover, the encoder/decoder architecture described herein introduces variability into the synthetic data, thereby enabling synthetic datasets to be shared in a manner that complies with the applicable privacy regulations.

Because the encoder/decoder architecture includes less trainable parameters, the training process may be performed more quickly, and convergence may be achieved substantially faster as compared to prior approaches. Thus, encoder/decoders in accordance with the present disclosure require fewer computational resources (e.g., fewer memory requirements, less processing or computing resources, etc.) for training while simultaneously being capable of handling multi-channel data. Also, unlike prior approaches that required feature extraction to be performed on single channel data before being processed, the encoder/decoder may be trained and used to generate synthetic data based on input datasets that may not have been pre-processed for feature extraction (e.g., raw data). In an aspect, security protocols and data privacy techniques (e.g., encryption, removing personally identifiable information (PII data) and other information linking the raw data to an individual, etc.) may be applied to synthetic copies of the raw data, thereby enabling individuals to retain control over original or raw data, while advancing science through the use of the synthetic data to study the signals contained in the synthetic data using machine learning techniques. It is noted that each piece of synthetic data generated in the manner described above with reference to FIGS. 3A-3C may maintain signals of interest based on the training of the encoder/decoder. For example, EEG data containing signals of interest may be used to train an encoder/decoder having an architecture designed in accordance with the present disclosure. During the training the encoder may perform feature extraction, where the features correspond to the signals of interest. The portions of the input data corresponding to the signals of interest may be retained during the compression and reshaping of the encoder outputs, thereby enabling the encoder/decoder to be trained to retain signals of interest when generating synthetic data.

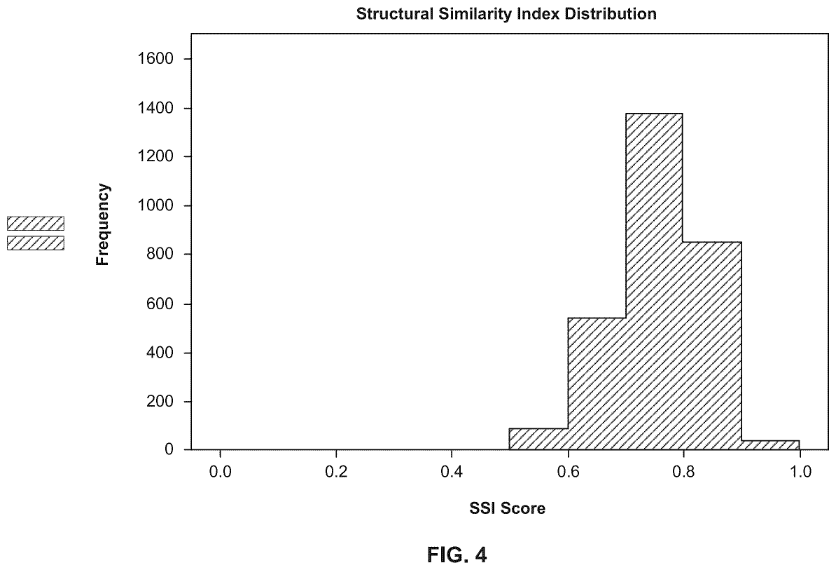

Referring to FIG. 4, a diagram illustrating the structural similarity of raw data to synthetic data generated in accordance with the present disclosure is shown. As briefly above, the encoder/decoder architecture disclosed herein enables synthetic data to be generated that is structurally similar (i.e., retains signals of interest) to the raw data used to generate the synthetic data. To demonstrate the structural similarity, an encoder/decoder configured in accordance with the concepts described herein was used to train on a publicly available dataset of EEG data representative of brain signals recorded while listening to music. The EEG data was used to create a synthetic version of the original dataset using the techniques described above with reference to FIGS. 3A-3C. To evaluate and validate the performance of the synthetic data generation techniques described herein and the quality of the synthetic data it generates, a Structural Similarity Index (SSI) metric was applied to all testing data, which looks at the informational difference between the original dataset and the synthetic dataset. While this metric is commonly used in computer vision to quantify perceptual differences of images, here such a metric considers the normalized difference in luminance, contrast, and structure where the range of values are between 0-1. The results are plotted in FIG. 4. As can be seen in FIG. 4, the average SSI produced between original and synthetic datasets was 0.7586, which translates to approximately 75% similarity along the specified features from the metric (luminance, contrast, and structure). This shows that the synthetic data is at a sweet spot of being different enough from the original dataset to not be a copy, which eliminates or reduces concerns with applicable privacy requirements, and potentially similar enough to still hold its original properties.

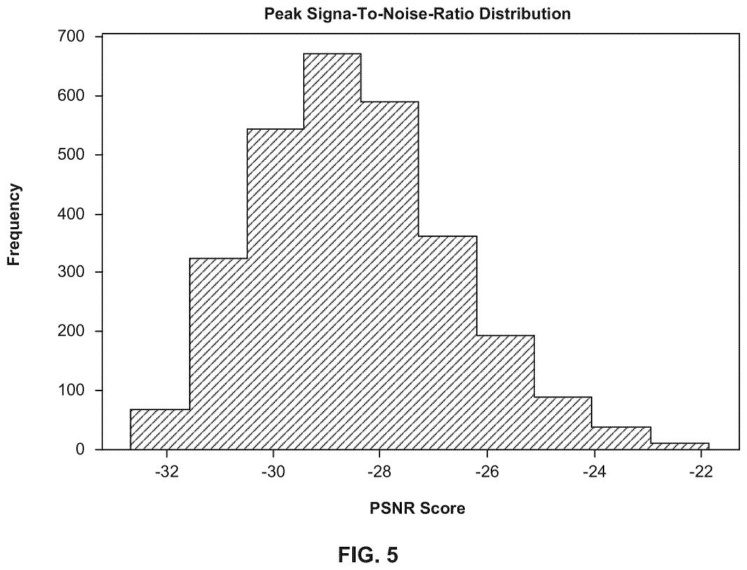

Referring to FIG. 5, a diagram illustrating informational differences between raw data and corresponding synthetic data generated in accordance with the concepts described herein is shown. A Peak Signal-to-Noise-Ratio Distribution (PSNR) was applied to all testing data, which looks at the informational difference between the original and synthetic datasets. This metric is commonly used in computer vision to compare how an original image is represented with its artificially generated counterpart. As shown in FIG. 5, the PSNR of the synthetic data was-28.44 dB, which is a comparable range towards good reconstructions from standard image generation models such as from GAN models. The negative value here represents the oscillatory nature of voltage potentials from brain waves, which shows evidence for the synthetic dataset being not noisy while still being different relative to the raw data.

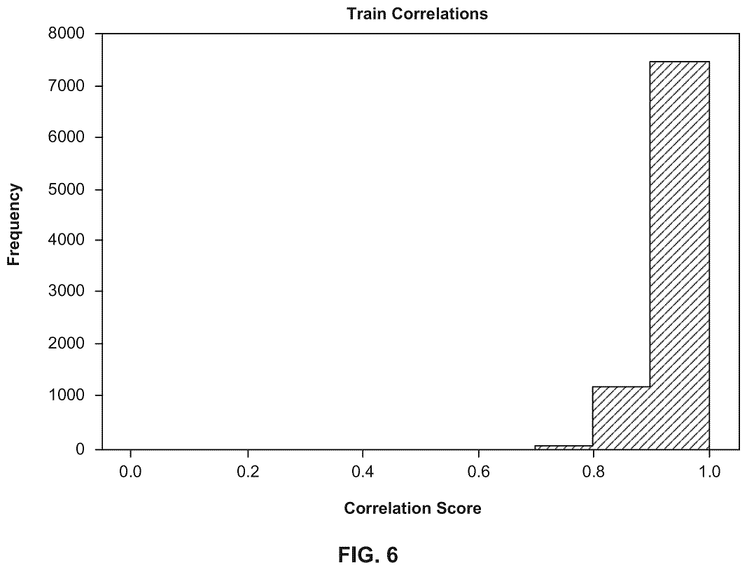

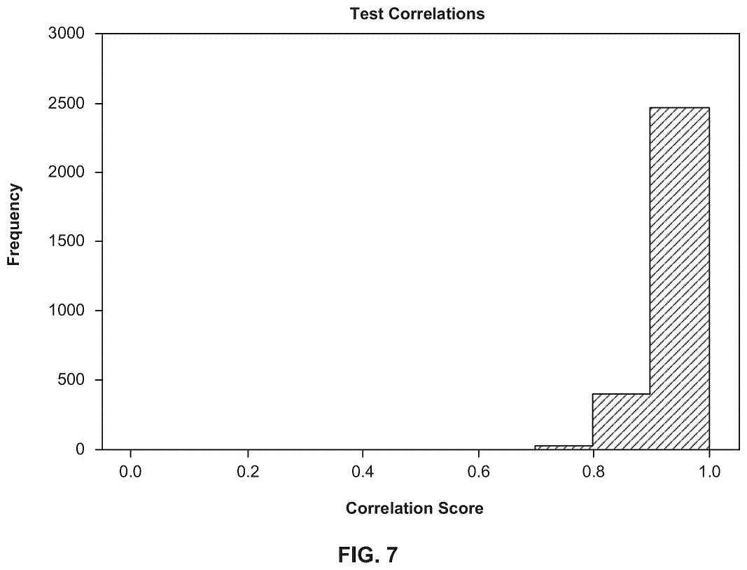

Referring to FIGS. 6 and 7, diagrams showing correlations between an original dataset and train and test splits for a synthetic dataset generated in accordance with the present disclosure are shown. Both the train and test splits demonstrated correlations with the original dataset, as can be seen by the pairwise correlations shown in FIGS. 6 and 7. This demonstrates evidence of a remaining statistical similarity despite the two datasets being different.

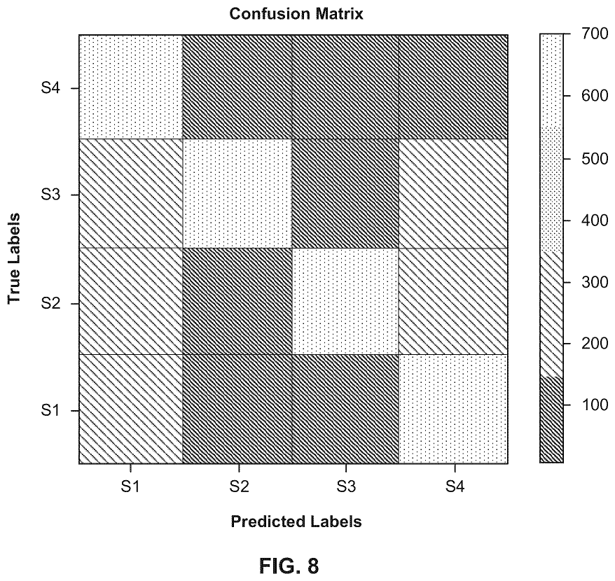

Referring to FIG. 8, a diagram illustrating retention of signals of interest within synthetic data generated in accordance with the present disclosure is shown. In particular, the exemplary EEG dataset described above represented brain signals of individuals recorded while the individuals were listening to music, where the specific songs the individuals were listening to were known. The synthetic data generated from the original recordings (i.e., raw EEG data) was then evaluated to detect when during a brain recording a participant was listening to a specific song. To facilitate the test, an AI model was trained to detect this for new incoming data from these participants. Given one second of their brain recordings, the newly trained AI model was able detect what specific song someone was listening to out of a total of four possible songs and the model accuracy was approximately 93% for unseen data from these participants. More specifically, the test resulted in accuracy score of 0.932639, a precision score of 0.934964, a recall score of 0.932639, an F1 score (e.g., based on the precision and recall scores) of 0.932703, and a Cohens kappa score of 0.910185. These metrics demonstrate that machine learning models, such as classifiers, can provide highly accurate predictions (e.g., classifications) based on synthetic data generated using the techniques disclosed herein and demonstrates the ability of encoder/decoders designed according to the present disclosure to retain signals of interest in the synthetic data.

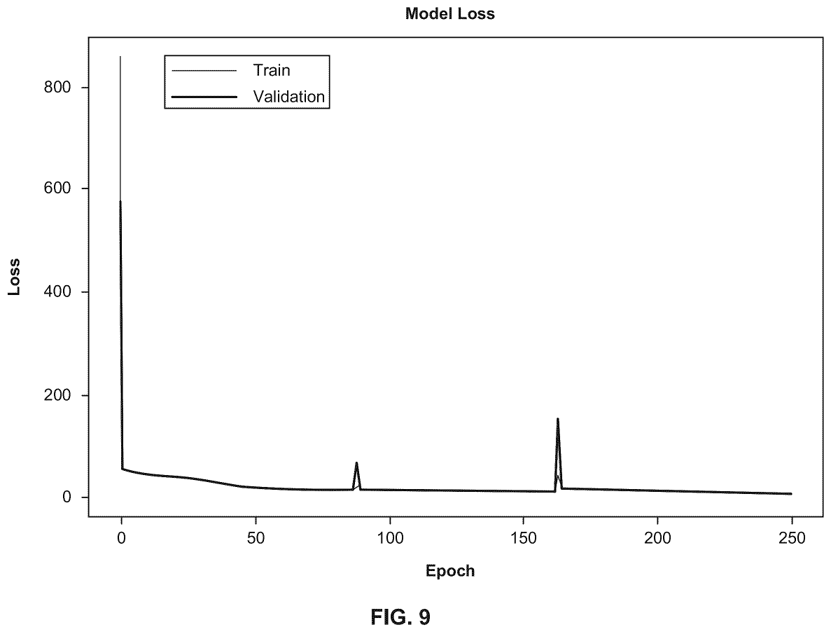

Referring to FIG. 9, a diagram illustrating performance of encoder/decoder architectures in accordance with the present disclosure. In particular, FIG. 9 illustrates that training of an encoder/decoder designed as described above may learn faster and be easier to train as compared to prior techniques. For example, training an encoder/decoder configured as described above with reference to FIGS. 2A-2D may achieve convergence in approximately 300 epochs, while DCGan-based and GPT-2-based (i.e., LLM based) techniques may require 3,000 or 1,000 epochs, respectively. As such, it is to be appreciated that the encoder/decoder architectures disclosed herein provide improved performance as compared to prior approaches.

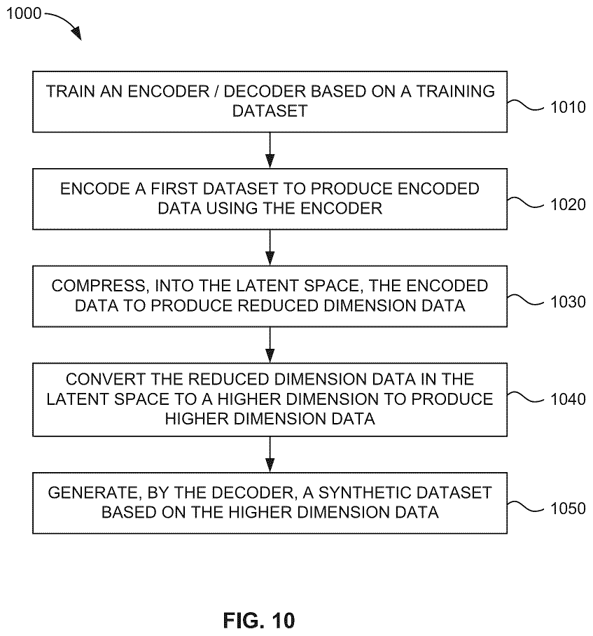

Referring to FIG. 10, a flow diagram illustrating an exemplary method for generating synthetic data in accordance with embodiments of the present disclosure is shown as a method 1000. In an aspect, the method 1000 may be performed by a computing device, such as the computing device 110 of FIG. 1. In an aspect, the method 1000 may be performed using an encoder/decoder having an architecture similar to, or the same as, the encoder/decoder architecture described above with reference to FIGS. 2A-2D. Steps of the method 1000 may be stored as instructions (e.g., the instructions 116 of FIG. 1) that, when executed by one or more processors (e.g., the one or more processors of FIG. 1), cause the one or more processors to perform the steps of the method 1000 to generate synthetic datasets in accordance with the concepts described herein.

At step 1010, the method 1000 includes training an encoder/decoder based on a training dataset. The encoder/decoder, once trained, is configured to generate synthetic data having variability with respect to an input dataset presented to the encoder/decoder. As explained above, the encoder/decoder comprises an encoder, a latent space, and a decoder. The encoder includes one or more selectively activatable dropout layers, which may be activated (i.e., turned on) or deactivated (i.e., turned off) during a particular iteration of the encoding. The encoder may be a CNN and the one or more selectively activatable dropout layers may be configured, when activated, to randomly disconnect connections between layers or nodes of the CNN to introduce variability in the synthetic dataset. The number of connections that are disconnected by the one or more selectively activatable dropout layers is configurable, such as by specifying the number or percentage of connections to be disconnected when the selectively activatable dropout layers are activated. It is noted that the training dataset may include raw data and/or synthetic data previously generated using the encoder/decoder.

At step 1020, the method 1000 includes encoding an input dataset to produce encoded data using the encoder. As explained above, the input dataset may include multi-channel data having one or more signals of interest and the encoder may be configured to shape the encoded data based on a number of channels within the multi-channel data. For example, if the first dataset includes EEG data having 128 channels, the encoder may shape the encoded data to be [128, 128, 1]. Particularly, upon receiving the input data, for example the EEG data, the encoder identifies and extracts meaningful features from the received EEG data based on the multiple channels. The features as described herein may include but not limited to frequency bands, temporal features, mean, variance, etc. In an embodiment, to extract the features, the encoder initially determines a number of channels included in the received input data based on the plurality of channels corresponding to the received input data and determines a plurality of model hyperparameters corresponding to the determined number of channels, wherein the plurality of model hyperparameters include a kernel size, filters, an activation function, a weight initialization, and a kernel regularizer. Then the encoder derives a correlation between each of the plurality of channels based on the determined plurality of model hyperparameters and extracts the plurality of features from the received input data based on the derived correlation between each of the plurality of channels.

Upon extracting the features, the extracted features are processed based on a plurality of factors corresponding to the plurality of channels. In an embodiment, processing the extracted plurality of features based on the plurality of factors corresponding to the plurality of channels includes determining the plurality of factors corresponding to the plurality of channels, wherein the plurality of factors include a number of recording channels, a time length of data in samples, and a depth length of data, and pulse-shaping electrical signals corresponding to the received input data based on the determined plurality of factors. That is, initially various factors that are relevant to the channels in the EEG data are identified. For example, number of recording channels (total count of electrodes used to capture the EEG data), a time length of data in samples (the duration of the EEG recording expressed in samples) and depth length of data (the number of features or depth of information extracted from the signals over time). Then the electrical signals corresponding to the input data is modified to enhance signal quality and this may include filtering, segmentation, normalization, etc.

Then a plurality of connections is selectively activated between network layers of an Artificial Intelligence (AI) model based on a configurable connection parameter, and an encoded data corresponding to the processed plurality of features is generated based on the selectively activated plurality of connections. Further, the encoded data is compressed to generate dimensional data in a lower dimension. That is, the encoder determines which connections between layers of the AI model will be active based on a configurable parameter, which may involve deactivating certain neurons during training to improve generalization. In one implementation, to selectively activate the plurality of connections between the network layers of the artificial-intelligence (AI) model, initially at least one connection among the plurality of connections is determined between the network layers to be one of an activated state and a de-activated state based on the processed plurality of features. For instance, if the features extracted from EEG data indicate that certain patterns are more relevant for classification (like specific brain wave activities during a task), the processor may decide to activate connections that correspond to those important features while deactivating others that contribute less to the task. The configurable connection parameter is configured to a specific value based on the determined at least one connection, wherein the configurable connection parameter indicates a number of connections being randomly activated and de-activated. This parameter might be configured based on a predefined probability or strategy. For instance, if a certain percentage (e.g., 20%) of connections is to be randomly activated or deactivated, this parameter would be set to reflect that number. Then, based on the configurable connection parameter, one of an activation and a deactivation of the determined at least one connection is selectively performed. If the parameter indicates that certain connections should be activated, those connections will be enabled for processing. Conversely, if connections are marked for deactivation, they will be turned off.

Then the encoder generates an encoded data corresponding to the processed plurality of features based on the selectively activated plurality of connections. This creates a new representation of the processed features based on the selectively activated connections. The output might be shaped to reflect the number of EEG channels and the features extracted, leading to an encoded format (e.g., [128, 128, 1]), where each channel's data is compactly represented.

At step 1030, the method 1000 includes compressing, by the latent space, the encoded data to produce reduced dimension data. As explained above, compressing the encoded data may include reducing a dimensionality of the encoded data. For example, the encoded data may be two-dimensional and the reduced dimension data may be 1-dimensional data. At step 1040, the method 1000 includes converting, by the latent space, the reduced dimension data to a higher dimension to produce higher dimension data. For example, if the reduced dimension data is 1-dimensional data, the higher dimension data may be two-dimensional data.

At step 1050, the method 1000 includes generating, by the decoder, a synthetic dataset based on the higher dimension data. The decoder generates the at least one primary synthetic dataset corresponding to the received input data based on the converted primary target dimensional data. The decoder initially synchronizes the plurality of factors corresponding to the target dimensional data to be in symmetric with the plurality of factors corresponding to the received input data and reconstructs the received input data with the source dimension by reshaping the primary target dimensional data based on the synchronized plurality of factors. That is, the decoder transforms the compressed data into a specific format or structure that aligns with the intended analysis. This might involve reshaping or reformatting the compressed data based on factors that correspond to the original channels, ensuring the output data maintains the necessary characteristics. For example, if the input EEG data has a certain number of channels, time length, and depth, the factors for the target dimensional data should match these attributes. For instance, if the input data has 128 channels and a time length of 2560 samples, the synchronized factors should also reflect these dimensions, ensuring that any transformations maintain the original data structure.

Then the decoder generates the at least one primary synthetic dataset corresponding to the received input data based on the reconstructed received input data, wherein the signal of interest are retained within the at least one primary synthetic dataset. The generated synthetic dataset resembles reconstructed multi-channel EEG data, capturing signals of interest (e.g., specific brain activity patterns). The dataset may be used for training models, validating analyses, or augmenting real EEG datasets for improved learning outcomes. As explained above with reference to FIGS. 4-8, the synthetic dataset may be different from the input dataset but retains the one or more signals of interest. Generating synthetic datasets using the method 1000 provides several advantages as compared to prior approaches for generating synthetic data for certain types of datasets, such as EEG and other types of multi-channel data. For example, the training performed at step 1010 may be completed more quickly due to the reduced number of trainable parameters of the encoder/decoder (e.g., converging in approximately 300 epochs as compared to 1,000 epochs or more using prior approaches). Moreover, the encoder/decoder architecture disclosed herein operates on multi-channel data simultaneously, rather than being restricted to a single channel as in prior approaches. Additionally, it has been shown that the encoder/decoder architecture disclosed herein operating in accordance with the method 1000 is able to retain signals of interest within the synthetic data while ensuring the synthetic data is sufficiently different from the raw data, resulting in the synthetic data being less likely to be subject to data privacy requirements and regulations and enabling the synthetic datasets to be more easily shared and distributed, such as to facilitate training of machine learning models (e.g., classifiers, etc.) for which large datasets are difficult to obtain. Such capability may enable new insights to be obtained in many fields, including the medical field, which may help develop new therapies and treatments for certain medical conditions.

It is noted that the method 1000 may also utilize other functionalities and features described herein to generate synthetic datasets. For example, the encoded data at step 1020 may be generated with the one or more selectively activatable dropout layers turned off, but a second synthetic dataset may be generated by processing at least a portion of the synthetic dataset, a portion of the first dataset, or at least a portion of both the synthetic and first datasets using the encoder/decoder with at least one dropout layer of the one or more selectively activatable dropout layers turned on. Additional variability may also be obtained by modifying the number of connections that are turned off by the activated dropout layer(s). In an aspect, additional training may be needed for different dropout layer configurations (e.g., training for disconnecting 5% of the connections in the CNN, 10% of the connections of the CNN, and the like). It is also noted that while examples described herein have been primarily discussed with respect to EEG data, the method 1000 is operable to generate synthetic datasets dataset for other types of datasets, such as datasets including MEG data, EOG data, ERG data, galvanic skin response data, EMG data, other types of multi-channel data, or a combination thereof. Accordingly, it should be understood that the method 1000 and the encoder/decoder architectures disclosed herein are not limited to applications involving EEG data and may instead be applied to a wide variety of datasets while retaining the various benefits and advantages described herein.

As described, the input data may be the raw data, or the synthetic data generated by the system. Further, the system may use the generated synthetic data as modified input data to generate large synthetic dataset.

In an embodiment, the system is further configured to retrain the machine learning model by analyzing the generated synthetic data. To do this, the system validates the trained machine learning model based on unseen input data and a plurality of performance metrics, wherein the plurality of performance metrics may include but are not limited to an accuracy score, a precision score, a recall score, an F1 score, and a Cohen's score. Then the system determines at least one error corresponding to the at least one primary synthetic dataset based on results of validation and further determines at least one modification to be made to the at least one primary synthetic dataset based on the determined at least one error, wherein the at least one modification rectifies the determined at least one error. Then the system updates the at least one primary synthetic dataset with the determined at least one modification and retrains the machine learning model using the updated at least one primary synthetic dataset.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIGS. 1-10) may comprise processors, electronics devices, hardware devices, electronics components, logical circuits, memories, software codes, firmware codes, etc., or any combination thereof. In addition, features discussed herein relating to FIGS. 1-10 may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 6-7) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CDROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to an embodiment or may relate to several implementations.

While this specification contains many specifics, these should not be construed as limitations on the scope of the disclosure or of what may be claimed, but rather as descriptions of features specific to implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive an input data from a plurality of data sources, wherein the input data corresponds to a multi-channel data, and wherein the input data comprises one of a raw data and a synthetic data and wherein the input data comprises a source dimension;
extract a plurality of features from the received input data based on a plurality of channels corresponding to the received input data;
process the extracted plurality of features based on a plurality of factors corresponding to the plurality of channels;
selectively activate a plurality of connections between network layers of an Artificial Intelligence (AI) model based on a configurable connection parameter;
generate an encoded data corresponding to the processed plurality of features based on the selectively activated plurality of connections;
generate a compressed dimensional data for the generated encoded data by compressing the generated encoded data into a lower dimension;
convert the compressed dimensional data into a primary target dimensional data based on a synchronized plurality of factors symmetric to the plurality of factors corresponding to the plurality of channels; and
generate at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest.

2. The system of claim 1, wherein to extract the plurality of features from the received input data based on the plurality of channels corresponding to the received input data, the processor is configured to:
determine a number of channels comprised in the received input data based on the plurality of channels corresponding to the received input data;
determine a plurality of model hyperparameters corresponding to the determined number of channels, wherein the plurality of model hyperparameters comprise a kernel size, filters, an activation function, a weight initialization, and a kernel regulizer;
derive a correlation between each of the plurality of channels based on the determined plurality of model hyperparameters; and
extract the plurality of features from the received input data based on the derived correlation between each of the plurality of channels.

3. The system of claim 1, wherein to process the extracted plurality of features based on the plurality of factors corresponding to the plurality of channels, the processor is configured to:
determine the plurality of factors corresponding to the plurality of channels, wherein the plurality of factors comprise a number of recording channels, a time length of data in samples, and a depth length of data; and
pulse-shape electrical signals corresponding to the received input data based on the determined plurality of factors.

4. The system of claim 1, wherein to selectively activate the plurality of connections between the network layers of the artificial-intelligence (AI) model based on the configurable connection parameter, the processor is configured to:
determine at least one connection among the plurality of connections between the network layers to be one of an activated state and a de-activated state based on the processed plurality of features;
configure the configurable connection parameter to a specific value based on the determined at least one connection, wherein the configurable connection parameter indicates a number of connections being randomly activated and de-activated; and
selectively perform one of an activation and a deactivation of the determined at least one connection based on the configurable connection parameter.

5. The system of claim 1, wherein the processor is configured to:
identify at least one event associated with a user by analysing the received input data; and
generate the at least one primary synthetic dataset corresponding to the received input data based on the identified at least one event, wherein the at least one primary synthetic dataset comprises a retained signal of interest corresponding to the identified at least one event.

6. The system of claim 1, wherein the processor is configured to:
train at least one machine learning model using the at least one primary synthetic dataset.

7. The system of claim 6, wherein the processor is configured to:
validate the trained at least one machine learning model based on unseen input data and a plurality of performance metrics, wherein the plurality of performance metrics comprise at least one of an accuracy score, a precision score, a recall score, an F1 score, and a Cohen's score;
determine at least one error corresponding to the at least one primary synthetic dataset based on results of validation;
determine at least one modification to be made to the at least one primary synthetic dataset based on the determined at least one error, wherein the at least one modification rectifies the determined at least one error;
update the at least one primary synthetic dataset with the determined at least one modification; and
re-train the at least one machine learning model using the updated at least one primary synthetic dataset.

8. The system of claim 1, wherein the processor is configured to:
determine at least one Structural Similarity Index (SSI) metric, and a Peak Signal-to-Noise-Ratio Distribution (PSNR) corresponding to the at least one primary synthetic dataset, wherein the SSI metric and the PSNR comprises at least one of a normalized difference in luminance, contrast, and structure corresponding to the at least one primary synthetic dataset;
validate a performance and a quality of the at least one primary synthetic dataset based on the determined at least one SSI metric, and the Peak Signal-to-Noise-Ratio Distribution (PSNR);
determine at least one error corresponding to the at least one primary synthetic dataset based on results of validation;
determine at least one modification to be made to the at least one primary synthetic dataset based on the determined at least one error, wherein the at least one modification rectifies the determined at least one error; and
update the at least one primary synthetic dataset with the determined at least one modification.

9. The system of claim 1, wherein to generate the at least one primary synthetic dataset corresponding to the received input data based on the converted primary target dimensional data, the processor is configured to:
synchronize the plurality of factors corresponding to the target dimensional data to be in symmetric with the plurality of factors corresponding to the received input data;
reconstruct the received input data with the source dimension by reshaping the primary target dimensional data based on the synchronized plurality of factors; and
generate the at least one primary synthetic dataset corresponding to the received input data based on the reconstructed received input data, wherein the signal of interest are retained within the at least one primary synthetic dataset.

10. The system of claim 1, wherein the processor is configured to:
receive the at least one primary synthetic dataset as a modified input data, wherein the modified input data corresponds to the multi-channel data, and wherein the modified input data comprises a target dimension;
extract a plurality of features from the received at least one primary synthetic dataset based on the plurality of channels corresponding to the received at least one primary synthetic dataset;
process the extracted plurality of features based on the plurality of factors corresponding to the plurality of channels;
selectively activate the plurality of connections between network layers of the artificial-intelligence (AI) model based on the configurable connection parameter;
generate the encoded data corresponding to the processed plurality of features based on the selectively activated plurality of connections;
generate the compressed dimensional data for the generated encoded data by compressing the generated encoded data;
convert the compressed dimensional data into a secondary target dimensional data based on the synchronized plurality of factors symmetric to the plurality of factors corresponding to the plurality of channels; and
generate at least one secondary synthetic dataset corresponding to the received least one primary synthetic dataset based on converted secondary target dimensional data, wherein the secondary target dimensional data corresponds to the primary target dimension and wherein the at least one secondary synthetic dataset corresponds to reconstructed multi-channel primary synthetic data and wherein the at least one secondary synthetic dataset comprises signal of interest.

11. The system of claim 1, wherein the processor is configured to:
iteratively modify the configurable connection parameter to an updated value based on the determined at least one connection, wherein the modified configurable connection parameter indicates a modified number of connections being randomly activated and de-activated; and
iteratively generate updated synthetic dataset corresponding to the modified configurable connection parameter.

12. A method comprising:
receiving, by a processor, an input data from a plurality of data sources, wherein the input data corresponds to a multi-channel data, and wherein the input data comprises one of a raw data and a synthetic data and wherein the input data comprises a source dimension;
extracting, by the processor, a plurality of features from the received input data based on a plurality of channels corresponding to the received input data;
processing, by the processor, the extracted plurality of features based on a plurality of factors corresponding to the plurality of channels;
selectively activating, by the processor, a plurality of connections between network layers of an Artificial Intelligence (AI) model based on a configurable connection parameter;
generating, by the processor, an encoded data corresponding to the processed plurality of features based on the selectively activated plurality of connections;
generating, by the processor, a compressed dimensional data for the generated encoded data by compressing the generated encoded data into a lower dimension;
converting, by the processor, the compressed dimensional data into a primary target dimensional data based on a synchronized plurality of factors symmetric to the plurality of factors corresponding to the plurality of channels;
generating, by the processor, at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest; and
training, by the processor, at least one machine learning model using the at least one primary synthetic dataset.

13. The method of claim 12, wherein extracting the plurality of features from the received input data based on the plurality of channels corresponding to the received input data comprises:
determining, by the processor, a number of channels comprised in the received input data based on the plurality of channels corresponding to the received input data;
determining, by the processor, a plurality of model hyperparameters corresponding to the determined number of channels, wherein the plurality of model hyperparameters comprise a kernel size, filters, an activation function, a weight initialization, and a kernel regulizer;
deriving, by the processor, a correlation between each of the plurality of channels based on the determined plurality of model hyperparameters; and
extracting, by the processor, the plurality of features from the received input data based on the derived correlation between each of the plurality of channels.

14. The method of claim 12, wherein processing the extracted plurality of features based on the plurality of factors corresponding to the plurality of channels comprises:
determining, by the processor, the plurality of factors corresponding to the plurality of channels, wherein the plurality of factors comprise a number of recording channels, a time length of data in samples, and a depth length of data; and
pulse-shaping, by the processor, electrical signals corresponding to the received input data based on the determined plurality of factors.

15. The method of claim 12, wherein selectively activating the plurality of connections between the network layers of the artificial-intelligence (AI) model based on the configurable connection parameter comprises:
determining, by the processor, at least one connection among the plurality of connections between the network layers to be one of an activated state and a de-activated state based on the processed plurality of features;
configuring, by the processor, the configurable connection parameter to a specific value based on the determined at least one connection, wherein the configurable connection parameter indicates a number of connections being randomly activated and de-activated; and
selectively performing, by the processor, one of an activation and a deactivation of the determined at least one connection based on the configurable connection parameter.

16. The method of claim 12, further comprising:
validating, by the processor, the trained at least one machine learning model based on unseen input data and a plurality of performance metrics, wherein the plurality of performance metrics comprise at least one of an accuracy score, a precision score, a recall score, an F1 score, and a Cohen's score;
determining, by the processor, at least one error corresponding to the at least one primary synthetic dataset based on results of validation;
determining, by the processor, at least one modification to be made to the at least one primary synthetic dataset based on the determined at least one error, wherein the at least one modification rectifies the determined at least one error;
updating, by the processor, the at least one primary synthetic dataset with the determined at least one modification; and
re-training, by the processor, the at least one machine learning model using the updated at least one primary synthetic dataset.

17. The method of claim 12, further comprising:
determining, by the processor, at least one Structural Similarity Index (SSI) metric, and a Peak Signal-to-Noise-Ratio Distribution (PSNR) corresponding to the at least one primary synthetic dataset, wherein the SSI metric and the PSNR comprises at least one of a normalized difference in luminance, contrast, and structure corresponding to the at least one primary synthetic dataset;
validating, by the processor, a performance, and a quality of the at least one primary synthetic dataset based on the determined at least one SSI metric, and the Peak Signal-to-Noise-Ratio Distribution (PSNR);
determining, by the processor, at least one error corresponding to the at least one primary synthetic dataset based on results of validation;
determining, by the processor, at least one modification to be made to the at least one primary synthetic dataset based on the determined at least one error, wherein the at least one modification rectifies the determined at least one error; and
updating, by the processor, the at least one primary synthetic dataset with the determined at least one modification.

18. The method of claim 12, wherein generating the at least one primary synthetic dataset corresponding to the received input data based on the converted primary target dimensional data comprises:
synchronizing, by the processor, the plurality of factors corresponding to the target dimensional data to be in symmetric with the plurality of factors corresponding to the received input data;
reconstructing, by the processor, the received input data with the source dimension by reshaping the primary target dimensional data based on the synchronized plurality of factors; and
generating, by the processor, the at least one primary synthetic dataset corresponding to the received input data based on the reconstructed received input data, wherein the signal of interest are retained within the at least one primary synthetic dataset.

19. The method of claim 12, further comprising:
receiving, by the processor, the at least one primary synthetic dataset as a modified input data, wherein the modified input data corresponds to the multi-channel data, and wherein the modified input data comprises a target dimension;
extracting, by the processor, a plurality of features from the received at least one primary synthetic dataset based on the plurality of channels corresponding to the received at least one primary synthetic dataset;
processing, by the processor, the extracted plurality of features based on the plurality of factors corresponding to the plurality of channels;
selectively activating, by the processor, the plurality of connections between network layers of the artificial-intelligence (AI) model based on the configurable connection parameter;
generating, by the processor, the encoded data corresponding to the processed plurality of features based on the selectively activated plurality of connections;
generating, by the processor, the compressed dimensional data for the generated encoded data by compressing the generated encoded data;
converting, by the processor, the compressed dimensional data into a secondary target dimensional data based on the synchronized plurality of factors symmetric to the plurality of factors corresponding to the plurality of channels; and
generating, by the processor, at least one secondary synthetic dataset corresponding to the received least one primary synthetic dataset based on converted secondary target dimensional data, wherein the secondary target dimensional data corresponds to the primary target dimension and wherein the at least one secondary synthetic dataset corresponds to reconstructed multi-channel primary synthetic data and wherein the at least one secondary synthetic dataset comprises signal of interest.

20. A non-transitory computer readable medium comprising a processor-executable instructions that cause a processor to:
receive an input data from a plurality of data sources, wherein the input data corresponds to a multi-channel data, and wherein the input data comprises one of a raw data and a synthetic data and wherein the input data comprises a source dimension;
extract a plurality of features from the received input data based on a plurality of channels corresponding to the received input data;
process the extracted plurality of features based on a plurality of factors corresponding to the plurality of channels;
selectively activate a plurality of connections between network layers of an Artificial Intelligence (AI) model based on a configurable connection parameter;
generate an encoded data corresponding to the processed plurality of features based on the selectively activated plurality of connections;
generate a compressed dimensional data for the generated encoded data by compressing the generated encoded data into a lower dimension;
convert the compressed dimensional data into a primary target dimensional data based on a synchronized plurality of factors symmetric to the plurality of factors corresponding to the plurality of channels; and
generate at least one primary synthetic dataset corresponding to the received input data based on converted primary target dimensional data, wherein the primary target dimensional data corresponds to the source dimension and wherein the at least one primary synthetic dataset corresponds to reconstructed multi-channel input data and wherein the at least one primary synthetic dataset comprises signal of interest.
